(19) United States
(12) Patent Application Publication
(10) Pub. No.: US 2002/0123909 A1
(43) Pub. Date: Sep. 5, 2002

(54) Consumer electronic medical record file sharing system (CEMRFS)

(76) Inventor: Stephen Charles Salisbury, San Diego, CA (US)

Correspondence Address: STEPHEN C. SALISBURY, 1020 CONCORD STREET, SAN DIEGO, CA, 92106, US

(21) Appl. No.: 09/681,245

(22) Filed: Mar. 5, 2001

(51) Int. Cl. G06F 17/60

(52) U.S. Cl. 705/3; 711/4

(57) ABSTRACT

Methods to allow for patient/consumers to collect, store, organize, password protect, and share personal health, medical, dental, and pharmacy data without regard to healthcare provider systems are provided. Application software necessary for complete functionality is contained on a portable, pocket sized, re-write enabled compact disk. Application software necessary for providers (doctors, dentists, hospitals, pharmacies) to view, print, and modify data points is contained on the compact disk. Communication software for the automatic updating of patient information by provider billing/management systems is contained on the compact disk. All software functions necessary for the user/patient and providers to collect, store, update, organize, and share patient information is contained within the application software imbedded on the compact disk. The compact disk therefore is the medium for consumers to collect, organize, store, and share their patient information with providers authorized by the consumer thus optimizing the health history information available to providers. Providing this information to care givers at the time of service serves to improve care and protect the consumer from endangerment due to lack of health history information, care conflicts, and/or drug-drug interactions. Consumer/patient control of access to the application further serves to protect against breech of privacy and confidentiality.

### BACKGROUND OF INVENTION

Lack of patient information by healthcare providers continues to be a chief cause of patient injury and death. A Harvard Medical School study published in 1999 reported that 50,000 Americans died as a direct result of medical treatment conflict and/or drug-drug interactions. Similarly, multiple studies suggest that between 8% to 15% of Medicare hospital admissions are due directly or indirectly to the lack of patient medical information sharing between providers. Using the conservative estimate of 10%, these unnecessary hospital admissions cost the American taxpayer $40 billion annually.

Millions of dollars are spent annually by the healthcare industry in an attempt to achieve an electronic medical patient record. These efforts have failed largely due to the lack of common technology interfaces between doctors and other providers. Less than 50% of doctors have internet capability in their practices and less than 20% of healthcare organizations share a common computerized system which would allow sharing of patient medical data. Legal liability on the part of both patients and providers with respect to privacy also contribute to the problem. Additionally, pharmacy chains have no ability today for their pharmacy management systems to talk to the systems of other dispensing chains and therefore protect patients from drug-drug conflict dangers when multiple prescriptions are filled at pharmacies operated by unrelated organizations.

Thus, a need exists for an consumer/patient electronic medical record capable of collecting, storing, cataloging, and sharing patient health information with all medical, dental, and pharmacy providers without dependence upon provider's medical management system platforms, data processing capabilities, or Internet access.

### SUMMARY OF INVENTION

The present invention is directed toward a method of collecting, aggregating, and sharing all patient medical information. In one embodiment, the invention is directed toward enabling patient/consumers to collect, record, manage, control, and share all of their medical, dental, and pharmacy information with all doctors, dentists, pharmacists, and other health providers they authorize independent of provider data processing systems. Application software necessary to enable consumer/patients to share this data with providers is imbedded on a pocket sized, re-write enabled, compact disk.

In another embodiment, the invention is directed towards including all software applications necessary for medical, dental, and pharmacy providers to view, edit, update, and print those data elements authorized by the custodial consumer patient.

In another embodiment, the invention contains all software necessary for providers to automatically synchronize identified and predetermined patient information data subsets with similar patient information data subsets maintained in the provider's office management and/or provider billing systems.

In another embodiment, the invention provides the custodial patient/consumer complete control of all data through a master personal identification number (PIN) and password protection of individual data subsets.

### BRIEF DESCRIPTION OF DRAWINGS

FIG. 1A illustrates the size and shape of the re-write enabled compact disk.

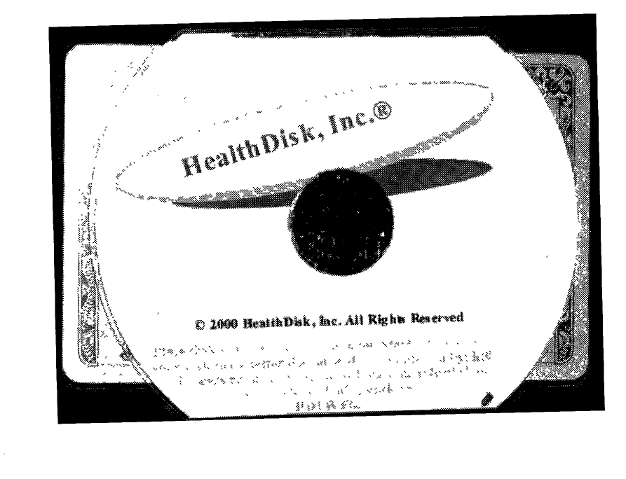

FIG. 1B is a photograph of an actual pocket sized compact disk

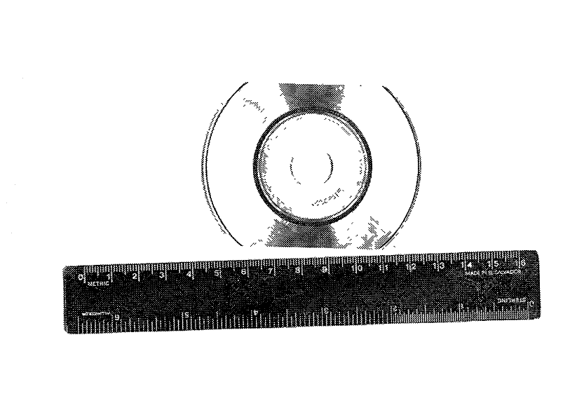

### DETAILED DESCRIPTION

The Consumer Electronic Medical Record File Sharing System is comprised of: 1) pocket sized, re-write enabled, compact disk, 2) encrypted, password protected, browser based application software capable of collecting, cataloging, storing, updating, and editing health history, medical encounter, dental encounter, and pharmacy record information and subsequently sharing that information with standard CD Rom computer drives, and 3) extensible markup language (XML) that communicates the resident data to standard doctor, hospital, and pharmacy office management software systems.

1. The compact disk is an irregular shaped rectangle measuring 8 cm long by 6.2 cm wide whose shape enables it to function in standard compact disk (CD-R/CD-r/w) trays without modification or accessories.

2. The application software utilizes the Microsoft platform, is browser based, and compatible with Microsoft Internet Explorer and Netscape browsers. The application software is operable with the supplied re-write enabled compact disk, the Internet, Web Enabled Cellular Telephones, Personal Digital Assistants, and other wireless devices. Patient/consumers may also input information directly via personal computer keyboard. An encryption program is imbedded into the application to accommodate secure transmission via internet and wireless computing devices. The application is accessible only when used with a consumer/user defined personal identification number (PIN). The user may also further password protect any subset of data within the application to prevent readability by those authorized to view other non-protected data subsets as defined by the consumer/user. The application software provides for the collection, storage, updating, organizing, and sharing of consumer/user; personal & family health history, demographic & insurance, medical treatment, dental treatment, pharmacy records, electrocardiograms, medical laboratory results, and other pertinent information within a series of predefined user and provider friendly screen modules.

3. The CEMRFS includes extensible markup language (XML) communication software that allows automatic communication and synchronization of data points in common between the system and the billing/office management software systems of doctors, hospitals, pharmacies, dentists, and other healthcare providers. These data points include, but are not limited to, date of service, medical/dental complaint, probable diagnosis, treatment rendered/recommended, and pharmacy prescriptions ordered/filled.

1. A software application methodology that enables consumer/patients to record, store, manage, update, and share personal health history, medical encounters, dental encounters, and pharmacy encounters with doctors, dentists, hospitals, pharmacies, and other healthcare providers.

2. A method according to claim 1, wherein a re-write enabled, pocket sized, compact computer disk is employed to independently record, store, and share patient information between patients and providers.

3. A method according to claim 1, wherein application software records, stores, organizes, updates and communicates health information from and to a re-write enabled, pocket size, compact computer disk.

4. A method according to claim 1, wherein access to healthcare information contained on a compact disk is privacy protected by means of a Personal Identification Number (PIN) created by the patient/user.

5. A method according to claim 1, wherein the application software resident on the pocket sized re-write enabled compact disk enables the application software to automatically exchange pre-defined data points such as, date of service, medical/dental complaint, probable diagnosis, treatment, and prescriptions with provider practice management and billing systems.

6. A method according to claim 1, wherein patient identified data sub-sets may be further password protected by the patient/user to prevent access by those authorized to access other non-protected data subsets.

7. A method according to claim 1, wherein the imbedded software application automatically updates patient health histories from data subsets associated with the application's medical, dental and pharmacy encounter screens and enables healthcare providers to view and/or print a current patient health history.
